(19) United States
(12) Patent Application Publication
(10) Pub. No.: US 2013/0001895 A1
(43) Pub. Date: Jan. 3, 2013

(54) METHODS AND DEVICES FOR SEALING STORAGE DEVICES

(76) Inventors: JUNG MOO SON, Gunpo-si (KR); Young June Park, Hwaseong-si (KR); Sung Yong Park, Suwon-si (KR)

(21) Appl. No.: 13/535,463

(22) Filed: Jun. 28, 2012

(30) Foreign Application Priority Data
Jun. 28, 2011 (KR) 10-2011-0062644

(51) Int. Cl. F16J 15/10; G11B 5/10

(52) U.S. Cl. 277/654; 277/628

(57) ABSTRACT

An apparatus includes a gasket disposed between a base and a flexible printed circuit bracket. A stiction between the gasket and flexible printed circuit bracket is greater than a stiction between the gasket and the base. The difference in stiction can be provided by differing materials and/or differing contact areas.

### RELATED APPLICATION

Pursuant to 35 U.S.C. §119(a), this application claims the benefit of Korean Application No. 10-2011-0062644, filed on Jun. 28, 2011, the contents of which are incorporated by reference herein in its entirety.

### SUMMARY

An apparatus includes a gasket disposed between a base and a flexible printed circuit bracket. A stiction between the gasket and flexible printed circuit bracket is greater than a stiction between the gasket and the base.

### BRIEF DESCRIPTION OF THE DRAWINGS

FIG. 1 is a perspective view of a hard disk drive, in accordance with various embodiments of the present disclosure.

FIG. 2 is an exploded perspective view of an assembly, in accordance with various embodiments of the present disclosure.

FIG. 3 is a bottom surface perspective view of the assembly in FIG. 2, in accordance with various embodiments of the present disclosure.

FIG. 4 is a schematic cross-sectional view of the assembly in FIG. 2, in accordance with various embodiments of the present disclosure.

FIG. 5 is a perspective view of a gasket, in accordance with various embodiments of the present disclosure.

FIG. 6 is a schematic cross-sectional view of an assembly, in accordance with various embodiments of the present disclosure.

### DETAILED DESCRIPTION

Data storage devices can be filled with air or sometimes a lower density gas, such as helium. Either way, to control a storage device's internal environment and to keep external debris from entering, storage devices can be sealed. Accordingly, the present disclosure relates to methods and devices for sealing storage devices.

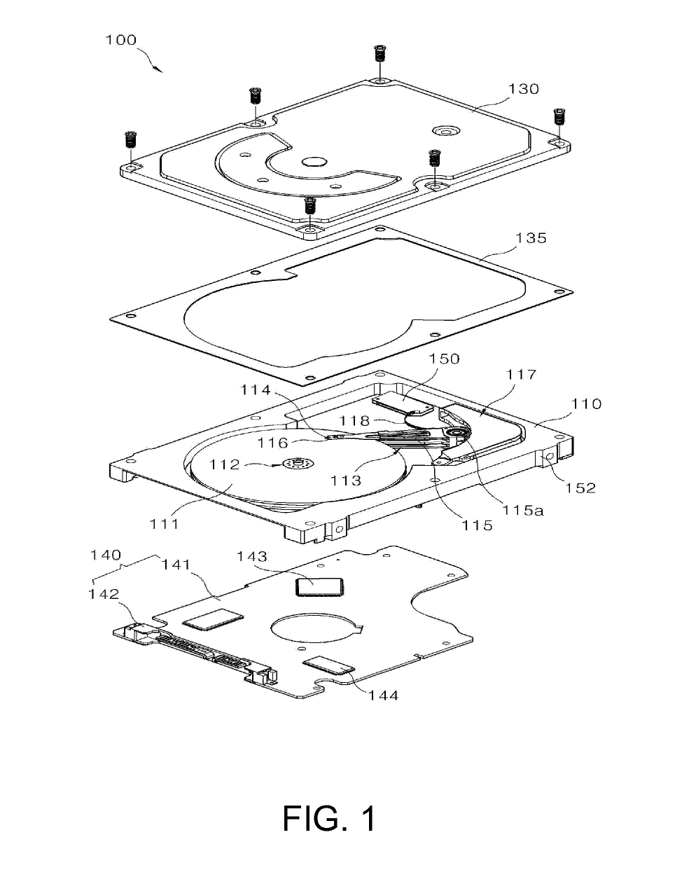

FIG. 1 is a perspective view of a hard disk drive 100 including a base 110, top cover 130, top cover gasket 135, and printed circuit board assembly (PCBA) 140. The top cover gasket 135 is disposed between the top cover 130 and base 110 to maintain air tightness between the top cover 130 and base 110. The gasket 135 is fabricated with a rubber material and forms a continuous closed loop shape along an upper surface of the base 110.

The base 110 can include components such as at least one disk 111 for recording and storing data, a spindle motor 112 to rotate the disk 111, and a head stack assembly (HSA) 113. The HSA 113 includes a magnetic head 114 for recording data on the disk 111 or reproducing recorded data. An actuator 115 moves the magnetic head 114—by operation of a voice coil motor 117—to allow the magnetic head 114 to access data on the disk 111. The magnetic head 114 is provided at a front end of a head gimbal 116 and maintains a gap between a surface of the disk 111 as it is rotated.

The magnetic head 114 records data to or reproduces data from the disk 111. That data is transmitted to the PCBA 140 by a flexible printed circuit 118. The PCBA 140 is positioned at an outer portion of the base 110. The PCBA 140 may include a printed circuit board (PCB) 141 on which a plurality of components are mounted including connector 142. For example, the PCB 141 can include a controller 143 and a plurality of memories 144.

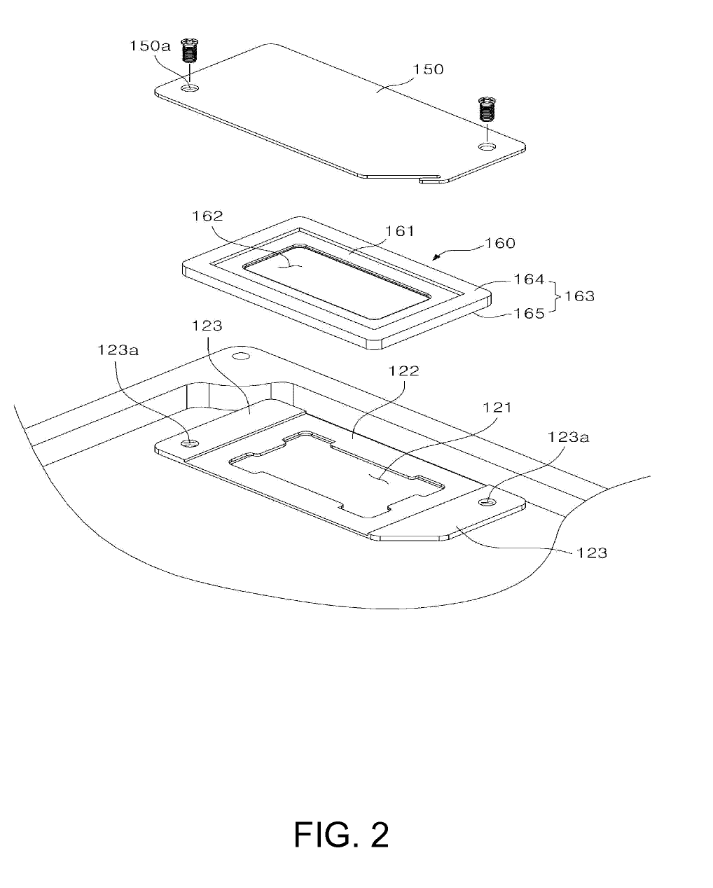

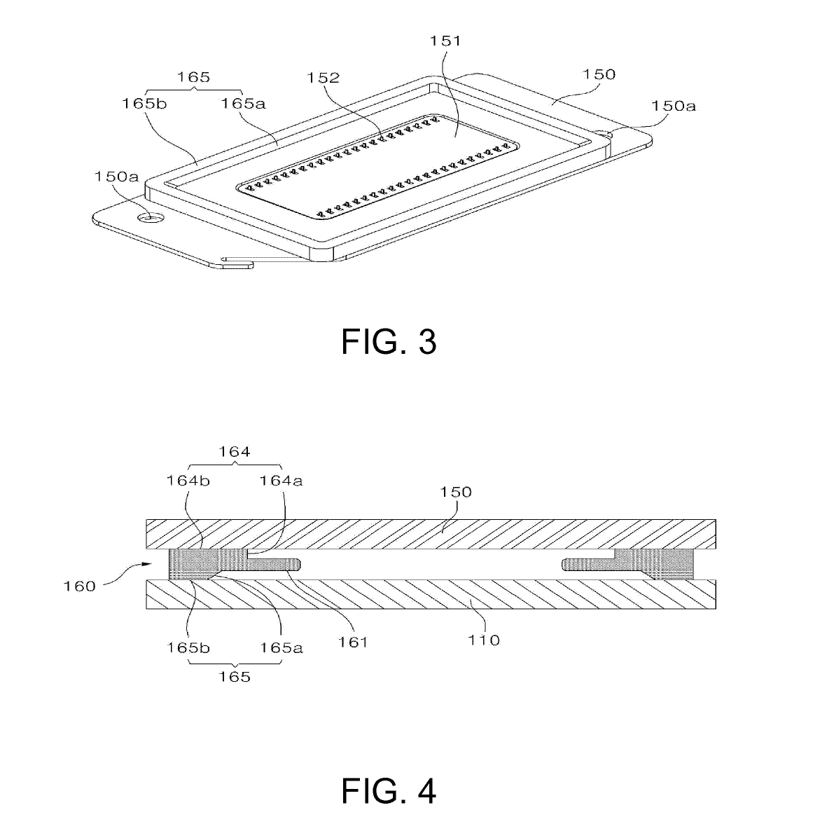

A through hole in the base 110 enables the flexible printed circuit 118 to connect to the PCBA 141, which is positioned outside the base 110. FIGS. 2-6 feature methods and devices for mitigating gas leakage via the through hole.

FIG. 2 shows the base 110 having a first through portion 121. A stepped portion 122 for mounting the gasket 160 to the base is provided around the first through portion 121. A boss portion 123 forms a first fastener hole 123a. A flexible printed circuit bracket 150 (hereinafter referred to as “bracket” because other types of brackets could be utilized) is positioned in a region of the first through portion 121. A second fastener hole 150a is at a position corresponding to the first fastener hole 123a so that the bracket 150 can be attached to the base 110.

The gasket 160 is disposed between the base 110 and the bracket 150 and mitigates gas leakage. The gasket 160 may include an inner sealing portion 161 that seals an inner region faced by the base 110 and the bracket 150. The gasket may also include a rim portion 163.

A second through portion 162 is formed at a central region of the inner sealing portion 161. A terminal member 151 may include terminals 152 for electrical connections. The gasket 160, base 110, and bracket 150 are assembled together so that the inner sealing portion 161 is brought into contact with the bracket 150 and the base 110, thereby creating a seal that suppresses leakage.

The inner sealing portion 161 has a thickness less than that of the rim portion 163. As a result, when the gasket 160 is pressed by the assembly of the bracket 150, a stiction to the base 110 due to pressure is less at the inner sealing portion than a stiction at the rim portion 163. The rim portion 163 may include an upper rim portion 164 located at an upper portion of the inner sealing portion 161 and brought into contact with the bracket 150, and a lower rim portion 165 located at a lower portion of the inner sealing portion 161 and brought into contact with the base 110.

Here, a contact area between the upper rim portion 164 and the bracket 150 is larger than that between the lower rim portion 165 and the base 110, thus providing a non-symmetric form with differing stictions between the gasket/bracket and gasket/base.

As an example of a non-symmetric form, the upper rim portion 164 may include a vertical portion 164a extending in a vertical direction from an upper portion of the inner sealing portion 161 toward the top side of the inner sealing portion 161. The upper rim portion 164 may also include an upper flat portion 164b extending from the vertical portion 164a to an outside of the inner sealing portion 161 and brought into contact with the bracket 150 to be horizontally located with respect to the inner sealing portion 161.

Furthermore, the lower rim portion 165 may include an inclined portion 165a extending from a lower portion of the inner sealing portion 161 toward the bottom side of the inner sealing portion 161. The lower rim portion 165 may also include a lower flat portion 165b extending from the inclined portion and brought into contact with the base to be horizontally located with respect to the inner sealing portion 161. Here, the lower flat portion 165b extends from the inclined portion 165a, thereby providing an area of the horizontal surface that is smaller than that of the upper flat portion 164b.

When an area of the upper flat portion 164b is greater than that of the lower flat portion 165b, a stiction between the upper rim portion 164 and the bracket 150 is greater than that between the lower rim portion 165 and the base 110. Because of the difference in stiction, the gasket 160 stays connected to the bracket 150 but not the base 110 when the bracket 150 is separated from the base 110 for rework (e.g., disassembled).

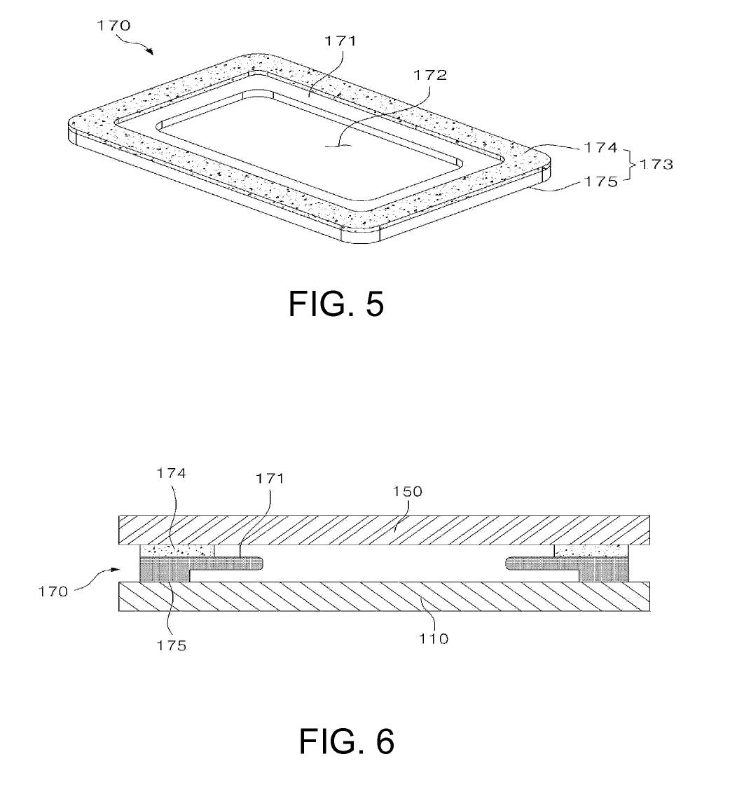

FIG. 5 shows a gasket 170 including an inner sealing portion 171 and a rim portion 173, which includes an upper rim portion 174 and a lower rim portion 175 with differing materials. The upper rim portion 174 is made from a material having a higher stiction than that of the lower rim portion 175, enabling the gasket 170 to adhere to bracket 150 and not the base 110 when disassembled during rework.

As a non-limiting example, the upper rim portion 174 can be provided with a fluoroelastomer material and the lower rim portion 175 with an ethylene-propylene diene monomer material. Through experimentation Applicants have found that fluoroelastomers exhibit a stronger stiction after pressure/assembly compared to ethylene-propylene diene monomers. Accordingly, the gasket 170 may remain connected to the bracket 150 and not the base 110 during disassembly. Fluoroelastomers and ethylene-propylene diene monomers are just examples of materials having different stiction properties that also prevents a gas, like helium, from leaking.

As shown in FIG. 6, the lower rim portion 175 and the inner sealing portion 171 can be the same material while the upper rim portion 174 is a different material stacked on an upper surface of the lower rim portion 175. The gasket 170 can be produced by a double injection process in which the inner sealing portion 171 and lower rim portion 175 are injected and the upper rim portion 174 is injected thereon.

A contact area between the upper rim portion 174 and the bracket 150 may be provided to be larger than that between the lower rim portion 175 and the base 110. When contact areas to the bracket 150 and base 110 are different in addition to differing materials of the upper rim portion 174 and lower rim portion 175, a stiction difference between the 174 and lower rim portion 175 can be further increased.

As described above, the gasket 160, 170 may be positioned between the bracket 150 and the base 110, thereby sealing the hard disk drive while also preventing the gasket 160, 170 from being separated from the bracket 150 during the disassembly process.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. An apparatus comprising:
a gasket positioned between a base and a bracket, wherein a stiction between the gasket and bracket is greater than a stiction between the gasket and the base.

2. The apparatus of claim 1, wherein the gasket contacts both the base and bracket, and wherein a contact area between the gasket and bracket is larger than a contact area between the gasket and the base.

3. The apparatus of claim 2, wherein the gasket includes a rim portion having an upper portion and a lower portion, and wherein the upper portion and lower portion are made from different materials.

4. The apparatus of claim 3, wherein the upper portion comprises a fluoroelastomer material and the lower portion comprises an ethylene-propylene diene monomer material.

5. The apparatus of claim 1, wherein the gasket includes a rim portion having an upper portion and a lower portion, wherein the upper portion contacts the bracket and the lower portion contacts the base.

6. The apparatus of claim 1, wherein the gasket is configured to seal a gas into a hard disk drive.

7. The apparatus of claim 6, wherein the gas is helium.

8. The apparatus of claim 1, wherein the gasket includes rim portion having an upper portion and a lower portion, and wherein the upper portion and lower portion are made from different materials.

9. The apparatus of claim 7, wherein the upper portion comprises a fluoroelastomer material and the lower portion comprises an ethylene-propylene diene monomer material.
